(19) United States
(12) Patent Application Publication
(10) Pub. No.: US 2018/0168927 A1
(43) Pub. Date: Jun. 21, 2018

(54) DEVICE FOR THE LIFE-LONG ADMINISTRATION OF VARYING DOSES OF A GEROPROTECTOR AND FOR INCREASING HORMESIS POST-ADAPTATION

(71) Applicants: Anatoly Viktorovich ZAZULIA, Krasnodar (RU); Vladimir Anatolevich ZAZULIA, Krasnodar (RU)

(72) Inventors: Anatoly Viktorovich ZAZULIA, Krasnodar (RU); Vladimir Anatolevich ZAZULIA, Krasnodar (RU)

(21) Appl. No.: 15/576,861

(22) PCT Filed: May 10, 2016
(86) PCT No.: PCT/RU2016/000278

§ 371 Date: Nov. 27, 2017

(51) Int. Cl. A61J 1/03; B65D 75/32

(52) U.S. Cl. CPC A61J 1/035; B65D 75/527; B65D 75/327

(57) ABSTRACT

The technical result of the invention is structurally creation of a biotechnical system of common blister pack elements consistently providing the drug substance with excellent ways of delivering a solid therapeutic dose orally or a liquid subtherapeutic dose sublingually.

The combination of individual separate delivery routes for solid therapeutic dose orally or a subtherapeutic liquid dose sublingually is a qualitatively new structural pharmacotherapy unit enabling the postadaptation hormesis effect. The advantage of the new drug form is elimination of the pre-systemic metabolism effect in liver with a subtherapeutic dose along with systemic bioavailability enhancement, prevention of drug destruction by chlorobutanol acid in the stomach and by alkaline contents in the intestines, and body resistance improvement.

The invention relates to medicine. The essence of the invention is creation of a device consisting of a blister pack with a solid and a liquid form of the drug.

The technical result of the invention is structurally creation of a biotechnical system from common elements of the blister pack that consistently provide the drug substance with an excellent delivery route for a solid therapeutic dose orally or a liquid sub-therapeutic dose sublingually.

1 independent claim and 3 subordinate claims, 2 figures.

The closest analogous solution of the invention claimed is a blister pack known from D1 (Claim 1, FIG. 4) in which the substrate film formed by blisters is attached to a flat film plate that comprises at least two parallel blister rows arranged one opposite the other, at that blisters of one row contain a solid drug. The blister pack claimed under formula Claim 1 differs from the known D1 packaging by the fact that blisters of the opposite row contain a liquid medication and, only after opening the blister with a solid form of the drug, the opportunity arises to open the blister with a liquid drug form.

From D2 (Item 6 of the formula, FIG. 2-4), the blister pack is known to comprise blisters with a liquid content.

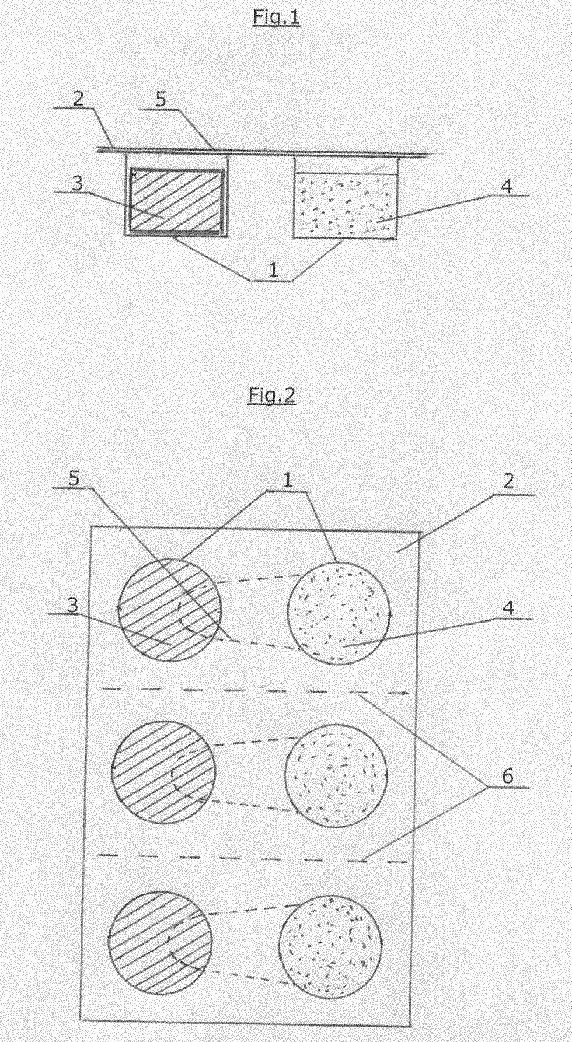

From D3 (FIG. 1A), the blister pack is known to be perforated in the manner the individual blister units can be separated from the blister pack.

From D4 (the abstract), the blister pack is known to contain two parallel blister rows folding along the folding line between the rows in the manner when the first row is shifted against the other row so that individual blisters of the first row are aligned with blisters of the second row with a shift to save space.

In 2005, a group of biogerontologists found underground in Africa a mammal species with unique qualities, naked mole rat (Heterocephalus glaber). Naked mole rats have a unique feature—it ages negligibly. Under negligible ageing, there is a zero correlation between the age and the death probability, neither the appearance nor the level of gene expression depend on age to a large extent. Achieving a negligible ageing is one of the prominent and manageable problems related to human life duration and quality, and geroprotector is the agent of choice.

Geroprotectors (agents to protect from senility) is the general name for a group of substances in which the ability was discovered to increase the life duration of animals and people. Geroprotectors have a positive impact on the quality of life organisms, including lifespan extension, stress resistance enhancement, reduce the speed of various age-related disease development, etc. Scientific geroprotector studies in animals actively influence ageing research in humans.

Geroprotectors significantly extend human youth and life—Metformin is the most studied and reliable drug slowing down cell ageing and prolonging life by 4-37% [5], aspirin prevents cancer, stroke, myocardial infarction, and stimulates lifespan extension by 8% [6], vitamins K1 and K2 reduce mortality by 43% and prevent cancer, stroke, myocardial infarction [7], vitamin B3 Nicotinamide ribozid increases life extension of model organisms by 240%, nicotinic acid protects human personality from acquired dementia (pellagra), senile dementia, depression, and aggression [8], doxycycline antibiotic slows down ageing of the whole organism, including brain ageing [9], glucosamine sulfate manifested cancer mortality reduction in humans by 13% and respiratory disease mortality—by 41% [10].

Healthy people longevity extension is also possible with geroprotectors (medical drugs) developed for ageing-related disease treatment in healthy people (mild immune activation, diabetes mellitus, cardiovascular diseases, cancer). An old rule remains in effect here: prevention is better than treatment—to prevent a disease is more preferable than to treat it. Geroprotector identification as an ageing-prevention factor can be of great importance for health.

The disadvantage of lifelong disease prevention and treatment under human ageing is the necessity of a gradual drug dosage increase due to a compensatory and adaptive organism response to this remedy. In this regard, a safety concern for its prolonged use arises assuming not only immediate adverse effects, but also resistance development to the geroprotector within the treatment period. Drug habituation causes the necessity of a long break in medication leading to the geroprotective effect loss and the necessity of a new drug selection.

The subject matter of this invention is a biotechnical system of combined elements in a blister pack of a special design to ensure a consistent delivery by individual different routes of a therapeutic dose in oral administering or of a subtherapeutic dose in sublingual administering to increase therapy efficiency.

In the published review of experimental and clinical studies “Postadaptation hormesis in perspective” [11], the group F. A. C. Wiegant, H. A. B. Prins, R. Van Wijk considered the beneficial effect of low dose stressor administration on cells or organisms that had been previously exposed to high stressor levels. The high degree of initial load (a high dose) activates the inborn self-healing mechanisms. Modulation of these endogenous adaptation strategies by introduction of subsequent low-level load (a low dose) can create effects very useful for biological systems. The research programme of Van Wijk and Wiegant was focused on the following question: can the postadaptation hormesis effect be demonstrated at the molecular synthesis level of stress proteins hsps 28, hsps 60, hsps 70, hsps 90 and hsps 100, and whether it affects the survival ability dynamics. Van Wijk and Wiegant (2006, 2010) used in a laboratory environment the cultured cells of rat hepatoma of Reuber H35 line that had been previously treated with a large dose of arsenit, copper, cadmium, mercury, lead, two different oxidative stress conditions (menadion and diethyldithiocarbamate) or with heat shock stress with the subsequent incubation at low doses of the initial stressor. It was proven that without a preliminary high-dose treatment, a low dose exposure to stress (stressor) used in the studies, did not stimulate a detectable synthesis of stress hsps proteins, and they (proteins) also failed to affect the survival ability. Cell cultures that were initially subjected to harmful stress conditions (a high dose) were incubated with lower dose of original stressor concentration in ratios from 1:10 to 1:100. Synthesis of heat shock hsps proteins and the survival ability enhanced due to hormesis postadaptation (Ovelgönne et al. 1995; Wiegand et al. 1997). The following increase of synthesis of heat shock proteins is interpreted as a positive phenomenon, as more chaperones will be involved in the post-stress recovery (Van Wijk and Wiegant 2006; Wiegant and Van Wijk 2010). There is a correlation between the severity of preliminary exposure conditions and post-exposure. The stiffer the initial stress conditions are, the less stressor concentration is required to stimulate the induction of stress heat shock hsps proteins and enhancement of the survival ability. Biopharmacy claims that the dosage form affects the pathological process in the body by the entire set of its properties (not merely by its active ingredient) and can be considered an important structural pharmacotherapy unit [12]. Therefore, the combination of individual separate delivery routes for solid therapeutic dose orally or a subtherapeutic liquid dose sublingually is a qualitatively new structural pharmacotherapy unit enabling the postadaptation hormesis effect. The advantages of the solid-liquid drug form are its convenience and ease of use, the possibility of postadaptation hormesis effect manifestation, a fast onset of drug efficacy. The advantage of the new form is elimination of the pre-systemic metabolism effect in liver with a subtherapeutic dose along with systemic bioavailability enhancement, prevention of drug destruction by chlorobutanol acid in the stomach and by alkaline contents in the intestines, and body resistance improvement.

Due to these reasons, pharmaceutical drug production is promising in combined blister packaging with a solid therapeutic dose for oral administering and a liquid subtherapeutic dose for sublingual administering. At first, the patient administers the solid oral therapeutic drug dose. Next, the administers the liquid subtherapeutic dose—the drug is poured out onto the tongue from the blister or in a teaspoon without water adding and the medicine shall be kept in the mouth before swallowing the saliva for 1-2 minutes.

This invention is structurally incorporated in the biotechnical system from shared elements of the blister pack structured as follows (FIG. 1, FIG. 2):

a) A relatively hard substrate film No. 1 comprising at least two parallel blister rows: one row contains a solid drug dose No. 3, and the other row opposite the first one contains blisters with a liquid solution No. 4 of a subtherapeutic drug dose.

b) A cover film No. 2 seals the blister opening.

c) Notches No. 5 for opening the cover film of the blister cell with a liquid drug dose.

g) Perforation lines on films No. 6.

Examples of materials for substrates are aluminum laminate, polyvinyl chloride (PVC), polyvinylidenechloride (PVDC), low density polyethylene (PET), polypropylene (PP) and other laminates. Examples of cover lining materials are solid aluminium, soft aluminium, paper, polyester, polyvinyl chloride (PVC), etc.

The most common blister sealing method is heating, and at least one thin film shall have thermoplastic properties.

The distinction of the claim from the known one consists in the possibility to unpack the blister pack with the liquid drug dose only after opening the solid dose, and the blisters are recognizable by patient's sense of touch and visually. Preferably, the blister pack has at least two groups: one group contains a solid drug dose and the other group contains the liquid subtherapeutic drug dose subject to be administered after the solid dose. Preferably, the blister pack has perforation executed in the manner when individual blister units containing solid and liquid drug doses can be separated from the blister pack.

6

The invention is applicable to all types of film materials for substrate and cover film linings, and to any number of blisters in a single pack, when the blisters are arranged at least in two rows one against the other.

The covering film is torn by punching when pressing your finger on the bottom of the blister cell. After that, the blister covering film for the liquid dose is separated from the substrate film by delamination along the notching line.

The machine for blister packaging production in compliance with the invention may be of conventional type, but it shall be provided with blister-filling facilities by alternating series of solid and liquid drug doses.

The shape of bubbles in blisters can be cylindrical, oval, semicircular, or parallelepipedal.

The example below illustrates the invention.

It is known that taurine deficiency occurs in the diet of a modern man unless seafood (scallops, mussels and clams) is constantly consumed [13].

Studies of mice lines with “taurine TauTKO Transporter knockout” evidenced for a quicker decrease of muscle mass in animals, quicker cell ageing and life expectancy reduction [14].

The research revealed that regular consumption of taurine additives reduces the risk of unexpected death of coronary heart disease, decreases high blood pressure, protects the heart from ageing, and reduces the risk of obesity [15]. Taurine amino acid delays brain ageing, reduces age-associated memory impairment and dementia [16]. Taurine amino acid suppresses systemic senile inflammation [17]. Taurine protects muscles from ageing, weakness, and laxity [18].

7

Taurine amino acid has a preventive effect for liver and kidney lesions with medication, alcohol, etc. [19]. Taurine deficiency can cause retina degeneration [20]. Taurine deficiency can cause a severe heart damage (dilated cardiomyopathy) which often results in death [21].

### EXAMPLE 1

Woman aged 36, blood donor, common hemoglobin 125-135. In the morning, she took 250 mg of taurine orally in tablets for 2 weeks as a preventive measure. At the next blood donation, hemoglobin was 103. The donor underwent the medical examination, and no specific disease was identified. In animal studies it was discovered that taurine amino acid is capable of lowering hemoglobin in blood [22].

Donor's hemoglobin value was adjusted by the post-adaptation hormesis effect with a solid and a liquid sub-therapeutic taurine dose. A taurine blister pack with a solid dose of 250 mg was used for oral administration in the morning and with a liquid subtherapeutic dose of 25 mg sublingually at night. After 2 weeks of taurine intake in these doses, the condition was subjectively improved, and performance capabilities increased. Donor's hemoglobin value was back to normal—130. Thus, use of blister packaging of solid and liquid subtherapeutic drug doses enables increasing the post-adaptation hormesis effect.

For these reasons, production of pharmaceutical taurine drug in blister packaging with a solid and liquid therapeutic sub therapeutic dose is advantageous.

The list of documents quoted in the search report:
D1 RU 2314786 C2 20 Jan. 2008
D2 RU 2548476 C2 20 Apr. 2015
D3 RU 2483708 C2 10 Jun. 2013
D4 U.S. Pat. No. 6,253,920 B1 3 Jul. 2001
[5] http://www.scienceagainstaging.com/Books/OBZOR_razvorot-final.pdf
[6] http://cancerres.aacrjournals.org/content/74/19_Supplement/2153.abstract
[7] http://www.ncbi.nlm.nih.gov/pubmed/24647393
[8] http://www.nature.com/nchembio/journal/v9/n11/full/nchembio.1352.html
[9] http://www.ncbi.nlm.nih.gov/pubmed/9972141
[10] http://link.springer.com/article/10.1007%252Fs10654-012-9714-6
[11] 7Dose-Response, 9:209-224, 2011 Formerly Nonlinearity in Biology, Toxicology, and Medicine Copyright © 2011 University of Massachusetts ISSN: 1559-3258 DOI: 10.2203/dose-response.10-004.Wiegant
[12] Pharmaceutics technology (in two volumes) Ed. by L. A. Ivanova.—M., Medicine, 1991.
[13] http://www.ncbi.nlm.nih.gov/pmc/articles/PMC2813349/[14]
[14] https://www.ncbi.nlm.nih.gov/pubmed/18407290
[15] https://www.ncbi.nlm.nih.gov/pubmed/11510759
[16] https://www.ncbi.nlm.nih.gov/pubmed/22903433
[17] https://link.springer.com/leaf-pricing/chapter/10.1007/978-3-319-15126-7_45
[18] https://www.ncbi.nlm.nih.gov/pmc/articles/PMC2994395/[19]
[19] https://www.ncbi.nlm.nih.gov/pmc/articles/PMC2994395/[20]
[20] https://www.ncbi.nlm.nih.gov/pubmed/1138364
[21] https://www.ncbi.nlm.nih.gov/pubmed/3616607
[22] https://www.ncbi.nlm.nih.gov/pubmed/21850928

1. Blister pack in which the film-substrate formed with blisters, attached to a flat film of height and which contains at least two parallel rows of blisters, wherein the blisters in one row with a solid drug located in front of the other blisters of a number of liquid form of the drug with the possibility of printing blisters with liquid form of the drug along the lines of cuts only after opening the blister with a solid form of the drug.

2. Blister pack according to claim 1 is characterized by notching lines on a flat film covering for opening the liquid drug form being arranged above the solid form blister.

3. Blister pack according to claim 1 is characterized by perforations executed with a possibility of separation from the blister pack of individual blister units containing a solid or a liquid drug dose.

4. Blister pack according to claim 1 is characterized by the possibility for the solid dose blister to be filled with a therapeutic dose in tablets, capsules, dragees, granules, or powder.

5. (canceled)

6. (canceled)

7. (canceled)
